(19) United States
(12) Patent Application Publication
(10) Pub. No.: US 2025/0351995 A1
(43) Pub. Date: Nov. 20, 2025

(54) Food Preparation Appliance Comprising A Housing And A Removable Cooking Utensil

(71) Applicant: SEB S.A., Ecully (FR)

(72) Inventors: Bernard Allemand, Ecully Cedex (FR); Gautier Fradet, Ecully Cedex (FR); Marie Dussart, Ecully Cedex (FR); Johann Petitallot, Ecully Cedex (FR); Guillaume Prieto, Ecully Cedex (FR); Frédéric Denis Seurat, Ecully Cedex (FR)

(73) Assignee: SEB S.A., Ecully (FR)

(21) Appl. No.: 19/210,596

(22) Filed: May 16, 2025

(30) Foreign Application Priority Data
May 17, 2024 (FR) 2405120

(51) Int. Cl. A47J 36/36; A47J 37/06

(52) U.S. Cl. CPC A47J 36/36; A47J 37/0641

(57) ABSTRACT

A food preparation appliance, includes:
a housing, including an access opening; and
a cooking utensil, having a cooking vat and a wall portion. The cooking vat is configured to be held in the housing,
the wall portion is configured to be reversibly coupled to the cooking vat, and
the wall portion is configured to at least partially obstruct the access opening. The food preparation appliance also includes
wherein safety system configured to disable at least one cooking function if the wall portion and/or the cooking vat is missing from the access opening, respectively, from the cooking space.

### TECHNICAL FIELD OF THE INVENTION

The present invention generally relates to food preparation appliances, and the invention particularly relates to food preparation appliances comprising a housing and a removable cooking utensil which can incorporate a wall portion.

### STATE OF THE ART

Food preparation appliances in the prior art commonly provide a cooking utensil with a cooking vat and a removable wall portion of the cooking vat. This wall portion is designed to obstruct an access opening to a cooking enclosure and forms a continuation of a housing wall when the cooking utensil is installed in the appliance. Such a cooking appliance can have safety-related drawbacks, particularly if the food preparation appliance is not properly configured before use. This type of food preparation appliance commonly uses a safety system that disables the cooking function when the wall portion does not obstruct the access opening. However, improper use of the cooking utensil, in particular positioning the removable wall without the cooking vat in place, can result in deterioration of the food preparation appliance and risk of injury to the user.

### DISCLOSURE OF THE INVENTION

One purpose of the present invention is to overcome the aforementioned drawbacks of the prior art and in particular, first of all, to provide a food preparation appliance comprising a cooking utensil and which limits the risk associated with misuse of the appliance by the user and thus avoids any risk of injury or burns, for example during a cooking cycle carried out by the food preparation appliance.

To this end, a first aspect of the invention relates to a food preparation appliance, comprising:
a housing, defining a cooking space and comprising an access opening to the cooking space,
a cooking utensil, comprising a cooking vat and a wall portion, in which: the cooking vat is designed to be held in the cooking space, the wall portion is designed to be reversibly coupled to the cooking vat, the wall portion, coupled to the cooking vat held in the cooking space, is designed to at least partially obstruct the access opening to the cooking space,
the food preparation appliance comprising a safety system designed to:
detect a presence or absence of the wall portion in the access opening,
disable at least one cooking function if the wall portion is missing from the access opening, characterized in that the safety system is further designed to:
detect a presence or absence of the cooking vat in the cooking space,
disable at least one cooking function if the cooking vat is missing from the cooking space.

According to the above embodiment, the food preparation appliance comprises a safety system designed to detect whether the wall portion mounted on the cooking utensil is correctly positioned on the cooking vat, but also whether the cooking vat is missing from the cooking space even though the wall portion might be correctly positioned in the access opening to the cooking space. Operating the food preparation appliance (that is, switching it on or starting a cooking cycle) is restricted or even disabled if the wall portion is not detected in its intended position for safe operation (obstructing the access opening to the cooking space) and/or if the cooking vat is not positioned in the cooking space.

The food preparation appliance can be defined by the following features, taken individually or in combination.

According to one embodiment, the cooking utensil comprises a coupling detection device, comprising at least one coupling indicator which can be moved between:
a resting position, occupied when the cooking vat is uncoupled from the wall portion,
an activated position, occupied when the cooking vat is coupled with the wall portion.

According to one embodiment, the coupling indicator:
is arranged on one of the cooking vat and of the wall portion,
is designed to be moved to the activated position by the other of the cooking vat and of the wall portion. As a result, only an effective coupling between the cooking vat and the wall portion can cause the coupling indicator to move into the activated position.

According to one embodiment, the coupling detection device comprises an elastic return member designed to exert a return force on the coupling indicator towards the resting position. In other words, as soon as the cooking vat and the wall portion are uncoupled, the coupling indicator is automatically returned to the resting position, thereby preventing the food preparation appliance from being switched on.

According to one embodiment, the coupling indicator is arranged on the wall portion, and the coupling detection device comprises a transmission member such as a rocker arm, comprising:
an input portion, designed to be actuated by a portion of the cooking vat at least during an operation in which the wall portion is coupled to the cooking vat,
an output portion, engaged with or in contact with the coupling indicator.

According to one embodiment, the portion of the cooking vat designed to actuate the input portion is off-center relative to the body of the cooking vat.

According to one embodiment, the safety system comprises a coupling sensor for detecting the coupling indicator at least in the activated position. A switch, such as a safety switch, can be provided to cut off a power supply circuit, such as the cooking means power supply circuit.

According to one embodiment, the food preparation appliance comprises cooking means with heating means and preferably also comprising a ventilation member, and the safety system is designed to disable the operation of the heating means, and preferably also to disable the operation of the ventilation member, if the wall portion is missing from the access opening and even if the cooking vat is present in the cooking space, or if the cooking vat is missing from the cooking space and even if the wall portion is present in the access opening.

According to one embodiment, the food preparation appliance comprises a human-machine interface, and the safety system is designed to send an information signal if the wall portion is missing from the access opening (or incorrectly positioned relative to the latter) and/or if the cooking vat is missing from the cooking space, in order to instruct the human-machine interface to send an information message to a user.

According to one embodiment, the food preparation appliance comprises an electronic control unit, connected to the cooking means, and/or to the human-machine interface, and/or to the safety system, and designed to control the operation of the food preparation appliance, in particular to deactivate or prevent it from being started if the wall portion is not detected in its correct position and/or if the cooking vat is missing from the cooking space, even if the wall portion is present.

According to one embodiment, the cooking utensil comprises a gripping interface, attached to the wall portion.

### DESCRIPTION OF THE FIGURES

Other features and advantages of the present invention will become more apparent from the following detailed description of one or more embodiment(s) of the invention, provided by way of one or more non-limiting example(s) and illustrated in the appended figures, in which:

FIG. 1 shows a perspective view of a food preparation appliance comprising, in particular, a housing and a cooking utensil;

FIG. 2 shows a perspective view of the cooking utensil in FIG. 1, comprising a cooking vat and a gripping interface coupled together;

FIG. 3 shows a perspective view of the cooking utensil in FIG. 2 with the cooking vat and gripping interface uncoupled;

FIG. 4 shows a perspective front view of the gripping interface of the cooking utensil in FIG. 2 or 3;

FIG. 5 shows a perspective rear view of the gripping interface of the cooking utensil in FIG. 2 or 3;

FIG. 6 shows a perspective top view of the cooking vat of the cooking utensil in FIG. 2 or 3;

FIG. 7 shows a cross-sectional view of the cooking utensil in FIG. 2 in a plane parallel to the y-z plane of the reference point in FIG. 2;

FIG. 8 shows a rear view of an inner part of the gripping interface of the cooking utensil in FIG. 2 or 3;

FIG. 9 shows a cross-sectional view of the inner part of the gripping interface in FIG. 8 in a cross-sectional plane II-II of FIG. 8;

FIG. 10 shows a cross-sectional view of the gripping interface of the cooking utensil in FIG. 8 in a cross-sectional plane I-I of FIG. 8 and part of the housing of the food preparation appliance;

FIG. 11 shows a perspective top view of the cooking vat of the cooking utensil in FIG. 2 or 3; with a lid to be coupled to the cooking vat;

FIG. 12 shows a perspective top view of the cooking vat of the cooking utensil in FIG. 2 or 3; with the lid coupled to the cooking vat;

FIG. 13 shows a schematic cross-sectional view, in a plane parallel to the y-z plane of the reference point in FIG. 2, of the cooking vat and of the gripping interface of the cooking utensil in FIG. 2 or 3, before coupling;

FIG. 14 shows the cooking vat and the gripping interface in FIG. 13 in a first coupling phase;

FIG. 15 shows the cooking vat and the gripping interface in FIG. 13 in a second coupling phase;

FIG. 16 shows the cooking vat and the gripping interface in FIG. 13, coupled together;

FIG. 17 shows a first variant embodiment of the cooking vat and of the gripping interface in FIG. 13;

FIG. 18 shows a second variant embodiment of the cooking vat and of the gripping interface in FIG. 13;

FIG. 19 shows a third variant embodiment of the cooking vat and of the gripping interface in FIG. 13.

### DETAILED DESCRIPTION OF EMBODIMENT(S)

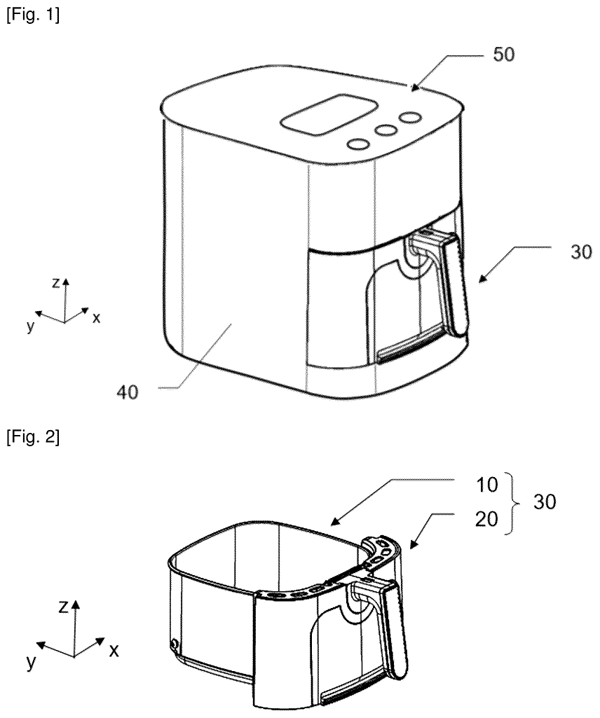

FIG. 1 shows a perspective view of a food preparation appliance, which in this example is a cooking appliance and comprises in particular:
a housing 40,
a cooking utensil 30,
a human-machine interface 50.

In the example in FIG. 1, the food preparation appliance is a household cooking appliance designed to cook food by radiation and/or convection. Cooking means, which are typically heating means and/or ventilation means, can therefore be provided in the housing 40. Heating means can comprise Joule heating means (one or more resistive heating elements), and ventilation means can comprise a ventilation member such as a motorized fan. However, conduction, induction, or even microwave heating means can also be provided.

The food preparation appliance in FIG. 1 typically comprises at least one electronic control unit and/or means for storing instructions or commands, and the human-machine interface 50 enables a user to select recipes, operating instructions, and to control and/or operate the food preparation appliance. The human-machine interface 50 can typically comprise a display and/or a touch screen, and control buttons.

The housing 40 forms an outer frame of the food preparation appliance, and the cooking utensil 30 comprises a wall portion that forms a front panel of the food preparation appliance, which extends the housing 40 (the surfaces are continuous and extend or are continuous with each other as can be seen in FIG. 1).

FIG. 1 shows a Cartesian coordinate system x/y/z, which is used to define, in particular, a width of the appliance along the x-axis, a depth of the appliance along the y-axis, and a height of the appliance along the z-axis. It can be seen in FIG. 1 that the human-machine interface 50 is arranged on top of the food preparation appliance, but it could be arranged on a side wall, on the front panel, or even (partially) offset on a portable electronic device.

FIG. 2 shows a perspective view of the cooking utensil 30 in FIG. 1, comprising a cooking vat 10 and a gripping interface 20 coupled together. In this exemplary embodiment, the cooking utensil 30 comprises a cooking vat 10 designed to hold food to be cooked and to be positioned in an inner cooking space formed inside the housing 40. Typically, when the cooking utensil 30 is held in the food preparation appliance as shown in FIG. 1, the cooking vat 10 positions the food held therein opposite the heating means and/or opposite the ventilation means.

In FIG. 2, the cooking vat 10 is coupled to the gripping interface 20 to form an assembly that is easy for a user to grasp and handle.

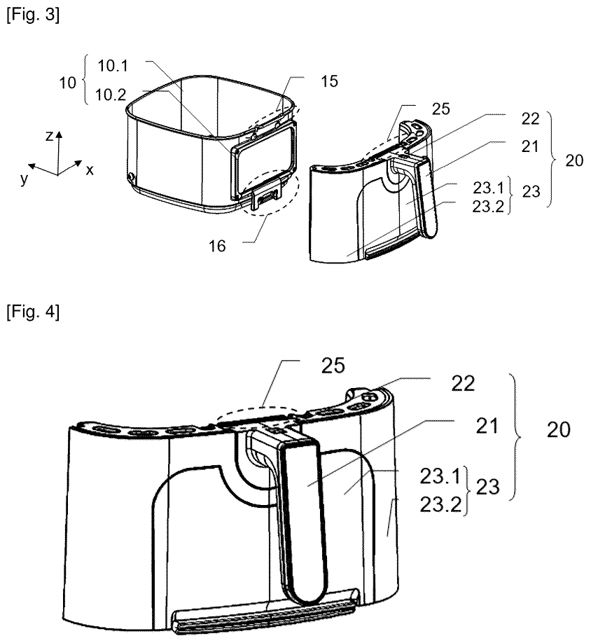

FIG. 3 shows a perspective view of the cooking utensil 30 in FIG. 2 with the cooking vat 10 and gripping interface 20 uncoupled and separated from each other.

In this FIG. 3, and in FIG. 4, it can be seen that the gripping interface 20 comprises:
a gripping handle 21,
a control button 22, located in the upper part of the gripping handle 21 (along the z-axis),
a wall portion 23, comprising a transparent glass pane 23.1 and an opaque wall 23.2,
an upper gripping attachment 25, mounted on the gripping interface 20 and located in the upper part of the gripping handle 21 (along the z-axis), behind the control button 22 (along the y-axis).

In FIG. 5, it can be seen that the gripping interface 20 comprises:
the control button 22, located in the upper part of the gripping handle 21,
the wall portion 23, comprising the transparent glass pane 23.1 and the opaque wall 23.2,
the upper gripping attachment 25, mounted on the gripping interface 20,
a lower gripping attachment 26 comprising in particular a movable hook 26.1 and fixed hooks 26.2 arranged on either side of the movable hook 26.1 along the x-axis.

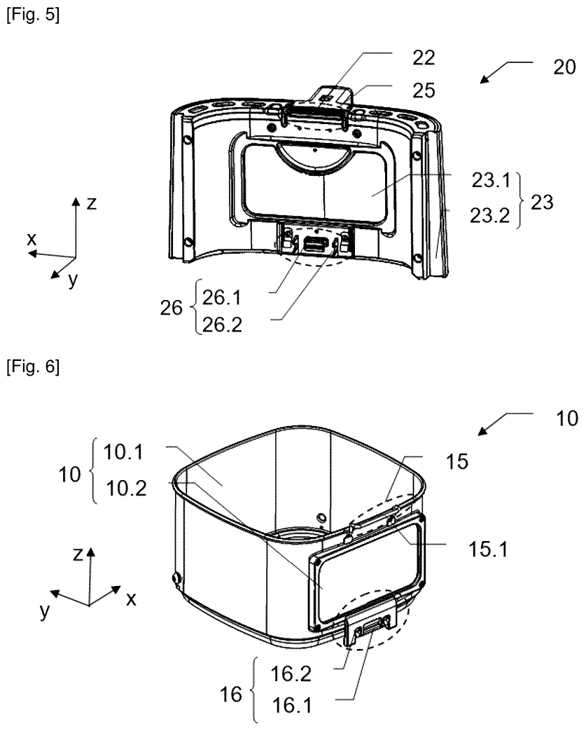

As shown in FIG. 3 and more specifically in FIG. 6, the cooking vat 10 itself comprises:
a body 10.1, forming a preferably metal vat,
a transparent viewing window 10.2,
an upper vat attachment 15, mounted on the cooking vat 10, arranged on an upper part of the cooking vat 10 along the z axis, and in particular comprising a support rod 15.1
a lower vat attachment 16, mounted on the cooking vat 10, arranged on a lower part of the cooking vat 10 and comprising in particular a locking rod 16.1 and positioning recesses 16.2 arranged on either side of the locking rod 16.1 along the x axis.

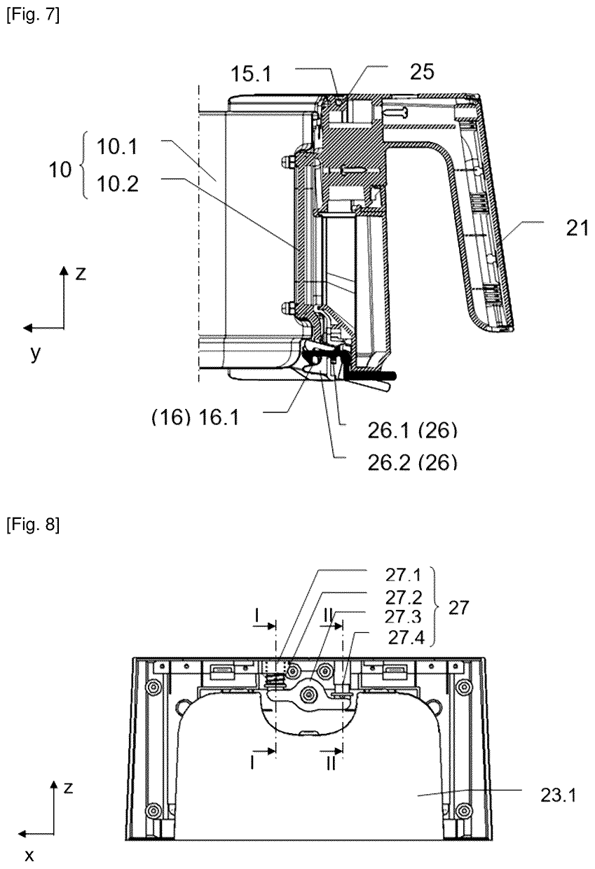

FIG. 7 shows a cross-sectional view of the cooking utensil 30 in FIG. 2, in a plane parallel to the y-z plane of the reference point in FIG. 2, to show the cooking vat 10 coupled with the gripping interface 20.

It can be seen in FIG. 7 that the upper vat attachment 15 and the upper gripping attachment 25 are engaged with each other. In particular, the upper gripping attachment 25 comprises a U-shape directed upwards along the z-axis, which holds the support rod 15.1 placed on the upper part of the cooking vat 10 along the z-axis. Thus, the weight of the cooking vat 10 is borne by the upper gripping attachment 25, which holds the support rod 15.1. The coupling of the upper gripping attachment 25 with its upwardly directed U-shape and the support rod 15.1 thus form a pivot connection between the cooking vat 10 and the gripping interface 20.

In the bottom part of FIG. 7, it can be seen that the lower gripping attachment 26 is engaged with the lower vat attachment 16. In particular, it can be seen that the fixed hooks 26.2 are engaged in the positioning recesses 16.2 (not shown in FIG. 7). Moreover, the movable hook 26.1 (in black) is lowered onto the locking rod 16.1. The movable hook 26.1 can be rotated around an axis parallel to the x-axis, as can be seen in FIG. 7, with the silhouette of the movable hook 26.1 angularly offset relative to the movable hook 26.1 in black.

As shown in FIG. 7:
the movable hook 26.1, engaged with the locking rod 16.1, prevents any rotation of the gripping interface 20 relative to the cooking vat 10;
in addition, the fixed hooks 26.2 engaged in the positioning recesses 16.2 limit the translational movement of the gripping interface 20 relative to the cooking vat 10 along the x and z axes.

The shape of the movable hook 26.1 is configured, in particular via the slope of its friction ramp which comes into contact with the locking rod 16.1 during the coupling movement of the gripping interface 20 on the cooking vat 10, so that it latches the attachment of the gripping interface 20 onto the cooking vat 10 when the cooking, vat 10 is inserted into the inner cooking space of the food preparation appliance. This reduces the risk of the gripping interface 20 actuating the safety system despite the fact that the upper vat attachment 15 and the upper gripping attachment 25 are engaged with each other but the lower gripping attachment 26 is not necessarily fully engaged with the lower vat attachment 16 before the cooking vat 10 is pushed into the cooking space.

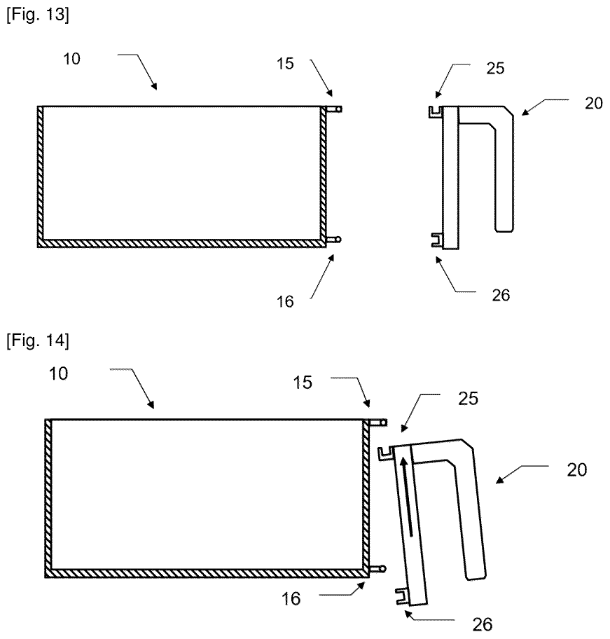

In the configuration in FIG. 7, the gripping interface 20 is locked in position relative to the cooking vat 10. When the movable hook 26.1 is moved (as a result of a user action on the control button 22) and occupies the angularly offset position of its silhouette in FIG. 7, the gripping interface 20 can be moved counter-clockwise relative to the cooking vat 10, and then the upper gripping attachment 25 (and its upward-pointing U-shape) can be moved downwards to release the support rod 15.1. The coupling and release sequence will be explained in more detail with reference to FIGS. 13 to 16.

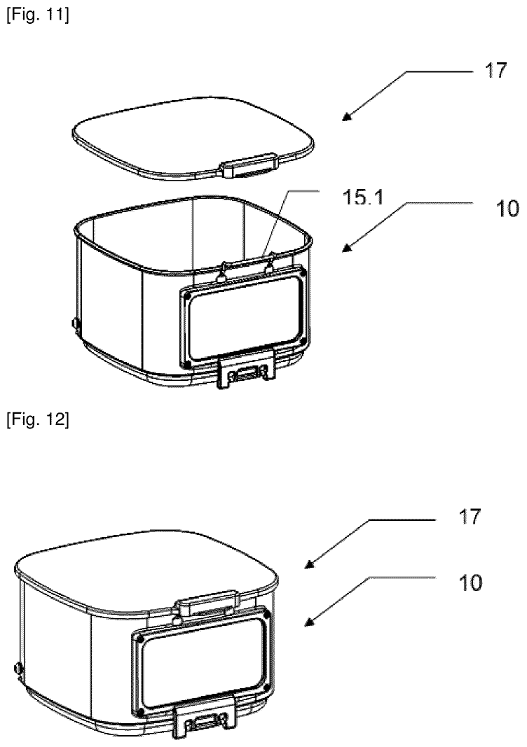

As shown in FIG. 8, the cooking utensil 30 can comprise a coupling detection device 27, comprising at least one coupling indicator 27.1 which can be moved between:
a resting position, occupied when the cooking vat 10 is uncoupled from the gripping interface 20,
an activated position (as shown in FIG. 8 or 10), occupied when the cooking vat 10 is coupled with the gripping interface 20. FIG. 8 shows a rear view of an inner part of the gripping interface 20 in FIG. 2 or 3 to clearly show the coupling detection device 27, comprising:
the coupling indicator 27.1,
a rocker arm 27.3, pivoting around a rocker axis,
a control piston 27.4, designed to be actuated by a keying member 10.3 attached to the cooking vat 10, and optionally
a return spring 27.2, designed to return the coupling indicator 27.1 downwards (along the z axis).

The return spring 27.2 is not essential, and there is no need for the coupling indicator 27.1 to occupy any position between the activated position and the resting position when the cooking vat 10 is released from the gripping interface 20.

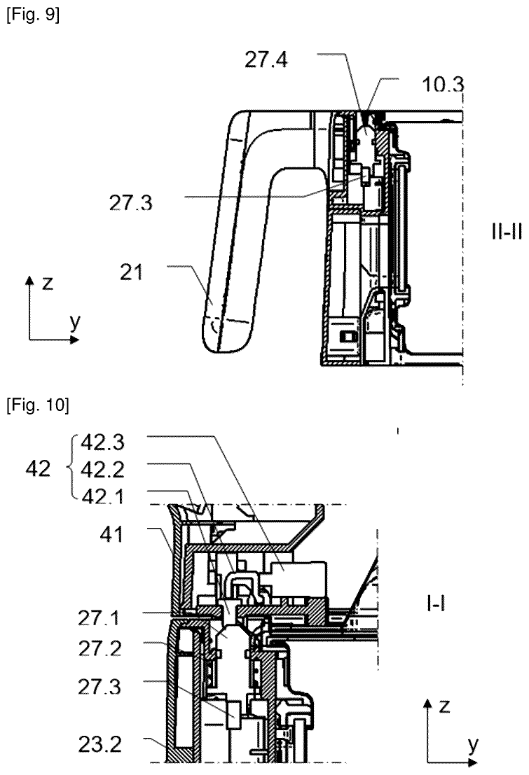

FIG. 9 shows a cross-sectional view of the cooking utensil 30 in FIG. 8, in a cross-sectional plane II-II in FIG. 8. It can be seen that the keying member 10.3 acts on the control piston 27.4 (pushing it downwards), which in turn acts on the rocker arm 27.3.

FIG. 10 shows a cross-sectional view of the cooking utensil 30 in FIG. 8, in a cross-sectional plane I-I in FIG. 8. It can be seen that the rocker arm 27.3 (pushed as shown in FIG. 9 by the control piston 27.4 and the keying member 10.3) pushes the coupling control 27.1 upwards despite the recall spring 27.2. As a result, a coupling detector 42 (comprising a feeler probe 42.1, a return lever 42.2 and a detection switch 42.3), located behind a wall 41 of the housing 40, can detect that the cooking vat 10 is indeed properly coupled with the gripping interface 20.

The gripping interface 20 can have a notch on its rear panel to allow the feeler probe 42.1 to be fed through and aligned with the coupling indicator 27.1 when the cooking utensil (cooking vat 10 and gripping interface 20) is inserted into the food preparation appliance.

Such a coupling detection device 27 can be part of a safety system to detect that the cooking vat 10 is properly coupled with the gripping interface 20 before starting the food preparation appliance. In particular, the control unit of the food preparation appliance can disable any operation or functionality of the food preparation appliance (and in particular the activation of the heating and/or ventilation means) if the cooking vat 10 is not coupled with the gripping interface 20. In fact, if the cooking vat 10 is not coupled with the gripping interface 20 and is nevertheless installed in the housing 40, the front panel of the food preparation appliance (the wall portion 23, comprising the transparent glass pane 23.1, the opaque wall 23.2, and mounted on the gripping interface 20) will be missing and operation would not be safe.

Similarly, if the front panel of the food preparation appliance is nevertheless installed on the appliance, but the cooking vat is missing, then the control unit of the food preparation appliance can prevent the food preparation appliance from being operated at all.

Additionally, the keying member 10.3 can comprise the support rod 15.1, so that when the upper vat attachment 15 and the upper gripping attachment 25 are engaged with each other, the control piston 27.4 is then pushed downwards and, under the action of the rocker arm 27.3, the coupling indicator 27.1 is pushed upwards.

In this case, the upper gripping attachment 25 of the gripping interface 20 comprises a groove for accommodating the support rod 15.1, and the control piston 27.4, in its raised position, extends into this groove without protruding beyond the height of the gripping interface 20.

The support rod 15.1 can also be slightly off-center towards the control piston 27.4 to enable the control piston 27.4 to be actuated without interfering with the movement of the coupling indicator 27.1.

FIG. 11 shows a perspective top view of the cooking vat 10 in FIG. 2 or 3, with a lid 17 to be coupled to the cooking vat 10. FIG. 12 shows a perspective top view of the cooking vat 10 in FIG. 2 or 3, with the lid 17 coupled to the cooking vat 10. It can be seen that the lid 17 comprises a coupling portion designed to couple with the support rod 15.1, for example by elastic interlocking (clip-on). Thus, the lid 17 is held securely on the cooking vat 10.

FIG. 13 shows a schematic cross-sectional view of the cooking vat 10 and of the gripping interface 20 in FIG. 2 or 3 before coupling, in a plane parallel to the y-z plane of the reference point in FIG. 2. It should be noted and remembered that:
the upper vat attachment 15 comprises in particular a support rod 15.1 and is located in FIG. 13 opposite the upper gripping attachment 25 which comprises in particular an upwardly-pointing U-shape
the lower vat attachment 16 comprises in particular the locking rod 16.1 and is located in FIG. 13 opposite the lower gripping attachment 26 which comprises in particular a movable hook 26.1 and fixed hooks 26.2.

FIG. 14 shows the cooking vat 10 and the gripping interface 20 in FIG. 13, in a first coupling phase, in which:
the gripping interface 20 is first moved downwards, and
the upper gripping attachment 25 (which comprises in particular an upwardly-pointing U-shape) is then moved upwards to engage the support rod of the upper vat attachment 15 in the U-shape of the upper gripping attachment 25.

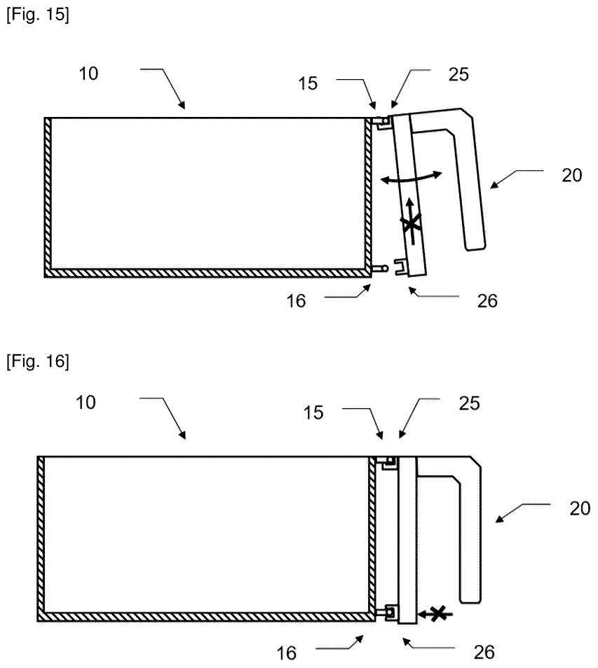

FIG. 15 shows the cooking vat 10 and the gripping interface 20 in FIG. 13 in a second coupling phase, in which:
the first coupling phase is completed, such that the U-shape of the upper gripping attachment 25 is holding the support rod of the upper vat attachment 15, thus ensuring a pivotal connection between the cooking vat 10 and the gripping interface 20,
no further upward movement of the upper gripping attachment 25 relative to the upper vat attachment 15 is possible,
pivoting between the cooking vat 10 and the gripping interface 20 is possible, in particular to bring the lower vat attachment 16 closer to the lower gripping attachment 26.

FIG. 16 shows the cooking vat 10 and the gripping interface 20 in FIG. 13, coupled together. Indeed, the second coupling phase is complete, with the lower vat attachment 16 contacting the lower gripping attachment 26. The movable hook 26.1 (shown in particular in FIG. 7) has been able to pivot and engage on the locking rod 16.1, so that no relative movement is possible between the cooking vat 10 and the gripping interface 20.

To release the cooking vat 10 and the gripping interface 20, all that is required is to actuate the control button 22 to pivot the movable hook 26.1 and be able to release the lower vat attachment 16 from the lower gripping attachment 26 by a relative rotational movement, and then move the gripping interface 20 towards the bottom of the cooking vat 10 to release the U-shape of the upper gripping attachment from the support rod of the upper vat attachment 15.

It should be noted that if the user unintentionally operates the control button 22 while normally holding the cooking utensil 30 by the gripping interface 20, the cooking vat 10 will not be released, as the weight of the cooking vat 10 itself:
forces the support rod 15.1 to remain in the U-shape of the upper gripping attachment 25, and
keeps the fixed hooks 26.2 pressed on the cooking vat 10. As a result, the cooking utensil 30 is easy to handle, the gripping interface 20 and the cooking vat 10 can be easily coupled or released, and user safety is guaranteed by eliminating the risk of inadvertent release, even if the user inadvertently presses the control button 22.

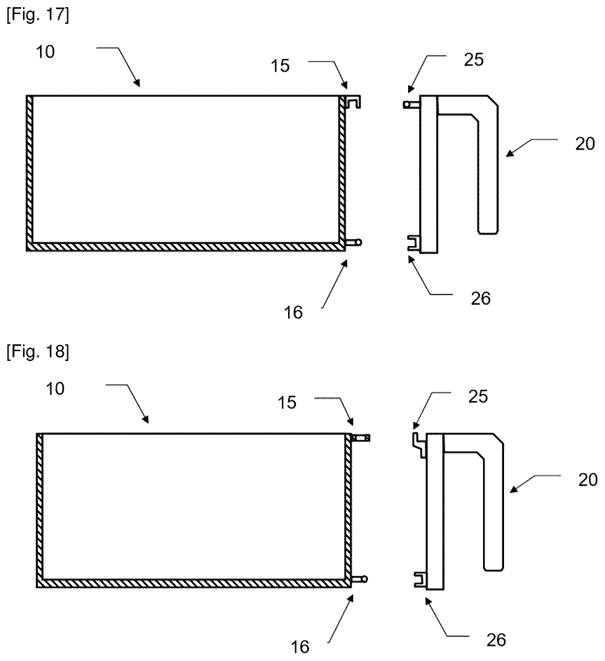

FIG. 17 shows a first variant embodiment of the cooking vat and of the gripping interface in FIG. 13, in which:
the upper vat attachment 15 comprises in particular a downwardly-pointing U-shape located in FIG. 17 opposite the upper gripping attachment 25, which in particular comprises a support rod,
as in FIG. 13, the lower vat attachment 16 comprises in particular the locking rod 16.1 and is located in FIG. 17 opposite the lower gripping attachment 26, which comprises in particular the movable hook 26.1 and the fixed hooks 26.2. Thus, as with the cooking utensil 30 in FIG. 13, the upper vat attachment 15 and the upper gripping attachment 25 in the first variant embodiment are designed to impose:
a movement to release the upper gripping attachment 25 having an uncoupling motion component directed towards the bottom of the cooking vat 10,
a movement to couple the upper gripping attachment 25 having a coupling motion component directed towards the top of the cooking vat 10.

FIG. 18 shows a second variant embodiment of the cooking vat and of the gripping interface in FIG. 13, in which:
the upper vat attachment 15 comprises in particular a support ring located in FIG. 18 opposite the upper gripping attachment 25, which in particular comprises an upward-pointing finger,
as in FIG. 13, the lower vat attachment 16 comprises in particular the locking rod 16.1 and is located in FIG. 18 opposite the lower gripping attachment 26, which comprises in particular the movable hook 26.1 and the fixed hooks 26.2. Thus, as with the cooking utensil 30 in FIG. 13, the upper vat attachment 15 and the upper gripping attachment 25 in the second variant embodiment are designed to impose:
a movement to release the upper gripping attachment 25 having an uncoupling motion component directed towards the bottom of the cooking vat 10,
a movement to couple the upper gripping attachment 25 having a coupling motion component directed towards the top of the cooking vat 10.

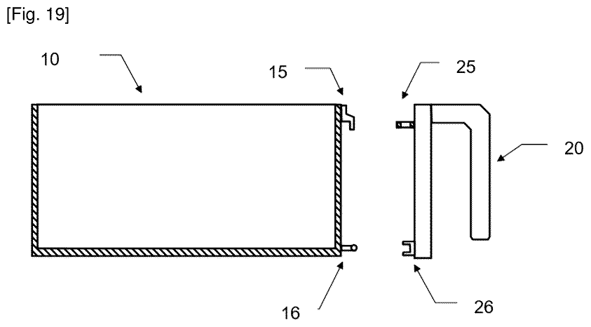

FIG. 19 shows a third variant embodiment of the cooking vat and of the gripping interface in FIG. 13, in which:
the upper vat attachment 15 comprises in particular a downward-pointing finger which is located in FIG. 19 opposite the upper gripping attachment 25, which comprises in particular a support ring,
as in FIG. 13, the lower vat attachment 16 comprises in particular the locking rod 16.1 and is located in FIG. 19 opposite the lower gripping attachment 26, which comprises in particular the movable hook 26.1 and the fixed hooks 26.2. Thus, as with the cooking utensil 30 in FIG. 13, the upper vat attachment 15 and the upper gripping attachment 25 in the third variant embodiment are designed to impose:
a movement to release the upper gripping attachment 25 having an uncoupling motion component directed towards the bottom of the cooking vat 10,
a movement to couple the upper gripping attachment 25 having a coupling motion component directed towards the top of the cooking vat 10.

### INDUSTRIAL APPLICATION

A cooking utensil according to the present invention, and the manufacture thereof, are suitable for industrial application.

It will be understood that various modifications and/or improvements that are obvious for the person skilled in the art may be made to the different embodiments of the invention described in this description without departing from the scope of the invention.

In particular, other structural embodiments can be provided to lock the cooking vat and the gripping interface: a removable pin, an elastic anti-return device, a clip, etc.

To detect the coupling, the rear side of the gripping interface can be designed to bear on an L-shaped toggle pin on the front side of the vat, thereby activating a switch on the appliance.

To detect the coupling, any kind of transmission mechanism can be provided to move the coupling indicator: a rocker arm as in the example provided, but a connecting rod, a lever, a cam, a cam track can also be provided, and the sensor attached to the housing can even be designed to directly detect the portion of the wall embedded in the gripping interface.

1. A food preparation appliance, comprising:
a housing (40), defining a cooking space and comprising an access opening to the cooking space,
a cooking utensil (30), comprising a cooking vat (10) and a wall portion (23), in which: .
the cooking vat (10) is designed to be held in the cooking space,
the wall portion (23) is designed to be reversibly coupled to the cooking vat (10),
the wall portion (23), coupled to the cooking vat (10) held in the cooking space, is designed to at least partially obstruct the access opening to the cooking space,
the food preparation appliance comprising a safety system designed to:
detect a presence or absence of the wall portion (23) in the access opening,
disable at least one cooking function if the wall portion (23) is missing from the access opening,
characterized in that the safety system is also designed to:
detect a presence or absence of the cooking vat (10) in the cooking space,
disable at least one cooking function if cooking vat (10) is missing from the cooking space.

2. The food preparation appliance according to claim 1, in which the cooking utensil (30) comprises a coupling detection device (27), comprising at least one coupling indicator (27.1), which can be moved between:
a resting position, which is occupied when the cooking vat (10) is released from the wall portion (23),
an activated position, which is occupied when the cooking vat (10) is coupled to the wall portion (23).

3. The food preparation appliance according to claim 2, in which the coupling indicator (27.1):
is arranged on one of the cooking vat (10) and of the wall portion (23),
is designed to be moved to the activated position by the other of the cooking vat (10) and of the wall portion (23).

4. The food preparation appliance according to any of claim 2 or 3, in which the coupling detection device (27) comprises an elastic return member designed to exert a return force on the coupling indicator (27.1) towards the resting position.

5. The food preparation appliance according to any of claims 2 to 4, in which the coupling indicator (27.1) is arranged on the wall portion (23), and in which the coupling detection device (27) comprises a transmission member such as a rocker arm (27.3), comprising:
an input portion, designed to be actuated by a portion of the cooking vat (10) at least during an operation in which the wall portion (23) is coupled to the cooking vat (10),
an output portion, engaged with or in contact with the coupling indicator (27.1).

6. The food preparation appliance according to claim 5, in which the portion of the cooking vat (10) designed to actuate the input portion is off-center relative to the body (10.1) of the cooking vat (10).

7. The food preparation appliance according to any of claims 2 to 6, in which the safety system comprises a coupling sensor (42) for detecting the coupling indicator (27.1) at least in the activated position.

8. The food preparation appliance according to any of claims 1 to 7, comprising cooking means with heating means and preferably also comprising a ventilation member, in which the safety system is designed to disable the operation of the heating means, and preferably also to disable the operation of the ventilation member, if the wall portion (23) is missing from the access opening and even if the cooking vat (10) is present in the cooking space, or if the cooking vat (10) is missing from the cooking space and even if the wall portion (23) is present in the access opening.

9. The food preparation appliance according to any of claims 1 to 8, comprising a human-machine interface (50), in which the safety system is designed to send an information signal if the wall portion (23) is missing from the access opening and/or if the cooking vat (10) is missing from the cooking space, in order to instruct the human-machine interface (50) to send an information message to a user.

10. The food preparation appliance according to any of claims 1 to 9, in which the cooking utensil (30) comprises a gripping interface (20) attached to the wall portion (23).
